(19) United States
(12) Patent Application Publication
(10) Pub. No.: US 2004/0263331 A1
(43) Pub. Date: Dec. 30, 2004

(54) Mould Alarm

(76) Inventor: Wolf-Dieter R. Berndt, Reno, NV (US)

Correspondence Address: Herbert C. Schulze, PMB36, 2790 Wrondel Way, Reno, NV, 89502, US

(21) Appl. No.: 10/611,689

(22) Filed: Jun. 30, 2003

(51) Int. Cl. G08B 21/00

(52) U.S. Cl. 340/540

(57) ABSTRACT

This is an algorithm, method, and means for mould detection in buildings and the like wherein one or more mould detection and notification devices is/are located in locations in the buildings and the like which may be susceptible to the growth of mould and locating a mould notification receiving and displaying device in an accessible location. Upon receiving a notification of possible mould, the mold detection device or a portion thereof is transported to an appropriate facility for determination of the type and severity of mould, if any.

### CROSS REFERENCE TO RELATED PATENT APPLICATIONS

There are no pending applications for patent filed by me related to this application.

### BACKGROUND OF THE INVENTION

I. Field of the Invention

This invention is in the general field of environmental monitoring;

The invention is more particularly in the field of environmental monitoring of buildings and the like;

The invention is most particularly in the field of environmental monitoring of buildings or the like for control of moisture and mould.

II. Description of the Prior Art

Until the present invention the prior art in detection of moisture and mould in buildings and the like has been confined to clumsy and laborious entry into building areas such as basements, crawl spaces, attics, and the like with equipment such as Petri dishes and the like to collect air samples by vacuum pumps or the like. The samples collected are then transported to an environmental microbiology laboratory or the like for evaluation. Such testing is inconvenient and expensive and does not provide immediate notification when a dangerous moisture or mould condition exists.

The present invention provides for instantaneous and automatic notification of moisture or mould problems when they first exist, much like the way a smoke detector provides instantaneous notice of a fire or the like. I have studied literature, patent indexes, and commercially available products. I have found nothing which suggests nor anticipates my present invention. Thus I believe there is no direct prior art as to this invention.

### SUMMARY OF THE INVENTION

Indoor air quality and condition is becoming an increasingly important topic and increasingly important factor to be considered with respect to a building's occupants and users. Over time such items as smoke alarms and sprinkler systems are used increasingly to assure safety as to fire and smoke conditions. Also, the imposition of no smoking rules in various buildings such as office buildings, restaurants and the like have aided in improving air quality for those within a building. Additionally such adverse airborne materials as asbestos an the like have received much attention.

Where I use the words “building” and “building or the like” and “buildings” and “buildings and the like” I mean any type structure or mechanism which could be susceptible to the growth of mould. For example this could include buildings, ships, cargo carriers, trucks, and any location susceptible to the growth of mould.

One very important component of indoor air in a building or the like is mould occurring in damp areas and the like. Unlike smoke, mould is not readily detected, yet it is a serious cause of illness in the elderly, and others.

Many persons visualize mould as a new asbestos type ingredient in the air. Moulds are microscopic organisms belonging to phylum mycophyta (fungi).

Moulds are closely related to mildews, mushrooms and puff balls. Moulds may look like black soot, but their color can vary greatly from green to brown or even pink. All moulds require a source of nutrients and humidity. Generally nutrients are not a limiting factor.

Virtually all moulds produce spores that are easily dispersed in the atmosphere. A single spore can establish a colony of moulds, and such a colony can produce millions of spores. A health problem typically occurs when a large number of spores are produced and bio-accumulate.

Bio-accumulation of mould spores can cause a chain reaction of continued mould spore growth throughout a building or the like. Early detection of potential bio-accumulation of mould spores is essential to preventing further contamination and minimizing the cost of remediation.

As previously stated, the present methods of mould detection are costly, inconvenient, and are undertaken only spasmodically. Therefore there are many instances of severe mold accumulation in buildings and the like resulting in dangerous health problems and excessive cost of remediation.

I have now conceived and developed a new algorithm, method, and means for mould detection, cure, and prevention. My invention involves the placing of a light emitting diode, or the like in series with a Petri-lens (a small bio-treated glass or plastic lens or the like which is a suitable medium for mould growth) and an electronic switch (switching transistor or the like). When sufficient mould has grown to interfere with proper transmission of light through the Petri-lens, the electronic switch will activate an alarm, or otherwise communicate that mould may be approaching a dangerous level in the location of the Petri-lens.

There can be one such Petri-lens in a most vulnerable place in the building or the like, or there may be many of such lenses connected to several alarms or the like where there are many potentially vulnerable areas.

It is an object of this invention to provide an algorithm, method, and means for detecting the presence of mould within a building or the like;

Another object of this invention is to provide such an algorithm, method, and means which can monitor the presence of mould at multiple locations within a building or the like;

Another object of this invention is to provide such an algorithm, method, and means which is economical in installation and operation;

Another object of this invention is to provide such an algorithm, method, and means which can be installed and utilized by unskilled persons.

The foregoing and other objects and advantages of this invention will become apparent to those skilled in the art upon reading the description of a preferred embodiment in conjunction with a review of the appended drawings.

### BRIEF DESCRIPTION OF THE DRAWINGS

FIG. 1 is a schematic, partially broken away, partially in phantom, elevation of a building containing multiple means for detecting probable mould and communicating such detection and practicing the algorithm and methods of this invention; and

FIG. 2 is a schematic side elevation of a means for detecting probable mould and communicating such detection and practicing the algorithm and methods of this invention.

### DESCRIPTION OF A PREFERRED EMBODIMENT

An inventory of items bearing reference numerals on the drawings is:

| Numeral | Item |
|---|---|
| 10 | building |
| 11 | foundation |
| 12 | steps |
| 13 | door |
| 14 | door knob |
| 15 | windows |
| 16 | wall |
| 17 | attic |
| 18 | basement |
| 19 | ground level |
| 20 | roof |
| 30 | mould detection device |
| 30a | light emitting device |
| 30b | Petri-lens |
| 30c | electronic switch |
| 30d | connection to notification device |
| 30e | light beam |

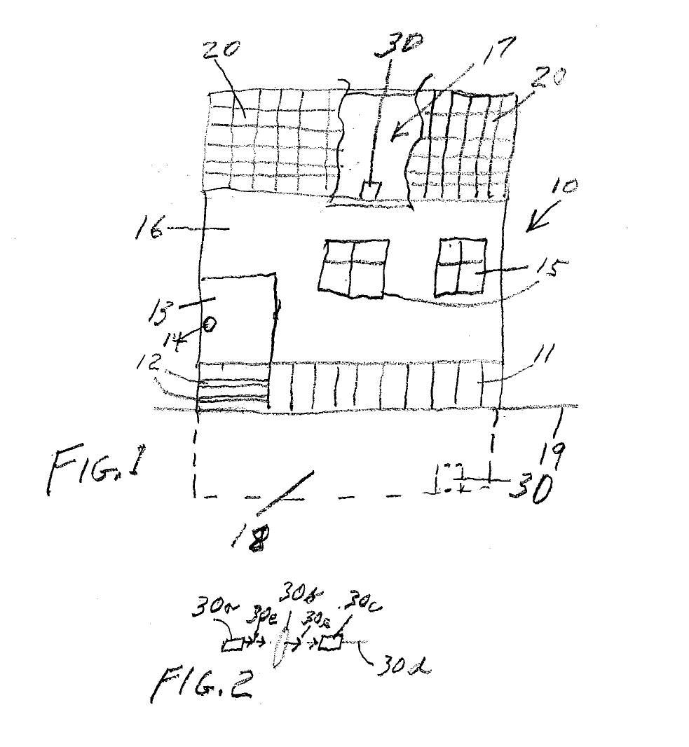

FIG. 1 shows a building 10 having foundation 11, front steps 12, door 13 with door knob 14, windows 15, wall 16, attic 17, basement 18 beneath ground level 19, and roof 20.

A device 30 suitable to be used in practicing the algorithm, methods, and means of this invention is shown installed in the attic 19 and another device 30 suitable to be used in practicing the algorithm, methods, and means of this invention is shown installed in the basement 18. It is understood that there could be many more devices 30 installed in various places in the building such as the foundation 11, the wall 16, etc.

The devices 30 may each be constructed of similar components including light emitting device 30a such as a light emitting diode or other light emitting device known to those skilled in the art. The light beam 30e will normally pass through Petri-lens 30b and onto an electronic switch or the like 30c which will remain open (off) so long as the light is present. When mould or the like builds on the Petrie-lens to the point where the light passing through the Petri-lens becomes diminished sufficiently to activate the electronic switch or the like it will close (on) and send a signal through wire or wireless communication means known to those skilled in the art and activate an alarm or other notification device (not shown, but known to those skilled in the art). The notification alarm or device may be arranged so as to differentiate and define which of several devices 30 is the one which is activated, as will be known to those skilled in the art.

This mould alarm system may have various deviant components. I have, for example, referred to light emitting diodes for a source of light to detect mould build up on a Petri-lens. It will be understood by those skilled in the art that mould build up can be detected by the electrical or physical characteristics of the Petri-lens which will be altered depending upon the presence of mould as will be understood by those skilled in the art.

Another important consideration in this system will be the effect of the characteristics of the air in which the Petri-lens is located. A properly controlled environment for the Petri-lens may include temperature control. A uniform appropriate temperature will make for a standardized condition for the Petri-lens and will thus give reliable moisture and mould production predictions. For example, I have found that a controlled environment of between fifty degrees Fahrenheit and one hundred fifty degrees Fahrenheit will be the optimum mould growing temperature. Within this range, the ideal will be at ninety-eight degrees Fahrenheit.

Other considerations will involve the use of existing bio-nutrient materials such as cellulose, agar and other laboratory culturing materials.

The exact geometric shape of the Petri-lens is another important factor. This can be based upon known culturing techniques and can be individually empirically established standards.

While I have described a particular mould detection device is to be understood that other such devices could be concocted without departing from the overall inventive algorithm, methods and means disclosed. For example, the mould detection device could be a fine screen which would pass light, but the openings in the screen which allow light to pass would become clogged so that no light would pass when there was sufficient mould build up. Also, a switch could be rigged by having an open contact which would close by reason of mould build up.

Another device for accomplishing the desired notification of mould build up can be a capacitance type device consisting of flat plates, concentric cylinders, or the like which are treated with bio-nutrients or the like. The dielectric value between the plates or the like will change depending on the growth of mould, which will be understood by those skilled in the art. This in turn can be detected, recorded and transmitted electronically, as will be understood by those skilled in the art. Other means for detecting the mould build up may occur to others without departing from the teachings and inventions disclosed in this specification.

By this reference I hereby incorporate the claims and abstract which follow as a part of this description of a preferred embodiment the same as though they were restated and rewritten here.

In the claims which follow if I should fail to claim a properly patentable feature such failure will be inadvertent and not an indication of an intent to abandon or dedicate such feature.

While the embodiment of this invention shown and described is fully capable of achieving the objects and advantages desired, such embodiment has been shown and described for purposes of illustration only and not for purposes of limitation.

I claim:

1. A business model algorithm for mould detection in a building comprising: placing at least one mould detection device with mould notification means in a building location susceptible to growth of mould; and installing a mould notification receiving means in a location where it can be observed or activated.

2. A business model algorithm for mould detection in a building comprising: placing a multiplicity of mould detection devices with notification means in a building location susceptible to growth of mould; placing a mould notification receiver device suitable to receive notification from each of the mould detection devices in a location where it can be observed or activated.

3. An Electro-Optic Sensor for detecting the presence of mould or fungi comprising: a bio-nutrient treated substrate; an electro-optical transmitter/detector suitable to detect changes in the substrate; and notification means suitable to communicate the presence of changes in the substrate.

4. A method for detecting in-situ (on going) growth of mould or fungi spores onto a bio-nutrient treated surface wherein the detection is by means of an electro-optical transmitter/detector.

5. The method of claim 4 wherein the electro-optical transmitter is a light emitting diode in the visible and infrared spectrum, and the detector is matched to detect the output of the electro-optical transmitter.

6. The method of claim 4 wherein the electro-optical transmitter is a monochromatic light source, and the detector is matched to detect the output of the electro-optical transmitter.

7. The method of claim 4 wherein the bio-nutrient surface on which the spores are permitted to grow is maintained at a constant temperature.

8. The method of claim 4 wherein the bio nutrient with which the surface is treated is a known laboratory culturing material.

9. The method of claim 4 wherein the bio nutrient with which the surface is treated is a partially synthetic composition specially formulated to enhance the growth of selected mould species.

10. The method of claim 4 wherein air circulation enhancement is provided in order to increase the probability of mould spore capture for growth on the bio-nutrient surface.

11. The method of claim 4 wherein the bio-nutrient surface is electro-statically charged for enhanced attraction of spores to the bio-nutrient surface.

12. The method of claim 4 wherein the bio-nutrient surface is a specially shaped geometric shape and configuration for maximum spore attract-ability.

13. The method of claim 4 wherein the electro-optical transmitter/detector includes notification means suitable to communicate information to a remote receiving means.

14. The method of claim 4 wherein the bio-nutrient surface is removed from its location and transported to a laboratory for examination after a period of time.

15. A mould alarm comprising: an electronic mould detector; a mould detection signal generator; a mould detection signal receiver; and a mould detection signal display.

16. A mould alarm comprising: at least two capacitance type devices coated with bio-nutrient at different planes from on another; means to detect the dielectric value between the capacitance type devices; and means to communicate the dielectric value to a location different from the location of the capacitance devices.

17. A mould alarm comprising: a mould detector; means to record mould detected by the mould detector; means to collect the mould detected; means to notify that mould exists; means to collect at least one sample of the mould detected; and means to analyze the sample.
